(19) United States
(12) Patent Application Publication
(10) Pub. No.: US 2019/0177856 A1
(43) Pub. Date: Jun. 13, 2019

(54) PRODUCTION METHOD OF A THICK COATING WITH LAYERED STRUCTURE

(71) Applicant: ISTANBUL TEKNIK UNIVERSITESI, Istanbul (TR)

(72) Inventors: Huseyin CIMENOGLU, Istanbul (TR); Erdem ATAR, Istanbul (TR); Murat BAYDOGAN, Istanbul (TR); Dogukan CETINER, Istanbul (TR); Ahmet Hilmi PAKSOY, Istanbul (TR); Hasan GULERYUZ, Sinop (TR); Onur TAZEGUL, Istanbul (TR)

(73) Assignee: ISTANBUL TEKNIK UNIVERSITESI, Istanbul (TR)

(21) Appl. No.: 16/321,836

(22) PCT Filed: Jul. 27, 2017
(86) PCT No.: PCT/TR2017/050356

§ 371 Date: Jan. 30, 2019

(30) Foreign Application Priority Data
Aug. 12, 2016 (TR) 2016/11359

(51) Int. Cl. C23C 24/04; C23C 4/02; B05B 7/14; C23C 4/18

(52) U.S. Cl. CPC C23C 24/04; C23C 4/02; B22F 2301/205; C23C 4/18; B05B 7/1486

(57) ABSTRACT

A method of producing a layered thick coating which has antibacterial properties, high-wear resistance and low friction coefficient on the surfaces of metallic materials. The objective is to provide a layered thick coating production method, which enables to form a titanium oxide layer exhibiting bioactive property on the outermost surface of the coating, and to produce a structurally denser coating as the zinc contained in the coating causes liquid phase sintering thereby filling the discontinuities in the coating structure.

### CROSS REFERENCE TO THE RELATED APPLICATIONS

This application is the national phase entry of International Application PCT/TR2017/050356, filed on Jul. 27, 2017, which is based on and claims priority from Turkish Patent Application 2016/11359 filed on Aug. 12, 2016, the entire contents of which are incorporated herein by reference.

### TECHNICAL FIELD

The present invention relates to a method of forming a layered thick coating which has antibacterial properties, high-wear resistance and low friction coefficient on the surfaces of metallic materials.

### BACKGROUND

Metallic surfaces require various improvements according to the fields of use and therefore various applications can be made on the material itself or the surface of the material depending on their functions. The applications made on the material surface are preferred for preserving material's own properties and for being more useful and easy. These improvement applications made on the material surface are named as surface coatings, and depending on the field of use and the desired wall thickness of the coating to be produced, they are carried out via various processes (immersion, spraying, chemical vapor deposition, (CVD), physical vapor deposition (PVD), etc.). Similarly, properties of the coating material that will be applied on the product will vary according to the field of use of the material to be coated and the properties that are desired to be contributed to the product. Titanium dioxide is one of the materials used for this purpose due to its high strength values and biocompatible structure.

In the state-of-the art applications, titanium oxide based coatings can be produced by using different methods such as physical vapor deposition (PVD), micro-arc oxidation or thermal spraying on the metallic substratematerial surface. In the PVD method used in these applications, thin film coatings are obtained. Although the obtained coating is of high quality, due to the fact that it is a thin film coating, wear-out occurs under high loads and accordingly life of the coating becomes short. In the method of micro-arc oxidation, which is another method used in the state of the art, the most basic restriction is the type of the substrate material that can be used. There is only one metallic substrate material that can be used to obtain titanium oxide and that is titanium or an alloy thereof. Another method used in the state of the art is thermal spraying. In these methods, during production of the coating;
Raising the temperature of the sprayed powders to high temperatures (semi molten or molten state) can cause formation of cracks or residual tensile stresses on the coating due to the rapid temperature changes.
In addition to these, high process temperatures may cause formation of molten regions on the surface or formation of cracks or splits on the coating/substrate interface depending on the properties of the substrate material.

In the patent applications realized on the basis of these state of the art applications, low friction coefficient feature of the obtained surfaces is indistinct or insufficient, and antibacterial property is provided only by Silver (Ag) element having toxicity potential.

The United States patent document no. US20140255874, an application known in the state of the art, discloses two methods developed for modification of the implant material surface. In the first one of these methods, the implant material (ceramic or metal) surface is first coated with a biocompatible material such as titanium or zirconium by using Physical Vapor Deposition (PVD) method. Then the coating is chemically converted to titanium oxide or zirconium oxide in NaOH. As the final stage, it is annealed at 600° C. thereby enhancing strength of the coating. The said patent document discloses about direct coating of the implant surface with calcium titanate or calcium zirconate materials by using spraying methods (plasma spraying, HVOF, cold gas dynamic spraying or magnetron spluttering) as second method.

The Chinese patent document no. CN102677125, an application in the state of the art, discloses about forming a titanium oxide layer on the surface of titanium and titanium alloys used as implant material. In the said patent document, the oxide layer on the surface is obtained at a single step by using micro-arc method. By addition of silver particles to the solution used for micro-arc process the oxide layer can be made antibacterial.

With the method of the patent document titled “Metal Implants” and numbered TR 2010/09282, an application in the state of the art, a single titanium layer is obtained. Plasma spraying method is used for obtaining this layer. Following this process, deposition of metal cations against infections on the coating surface is enabled by anodizing process or processing with phosphoric acid. Furthermore, it mentions about coating the obtained coating surface with hydroxyapatite or hydroxyapatite containing infection preventing metal cations.

The Chinese patent document no. CN103911593, an application in the state of the art, discloses about forming an Ag-doped TiO₂ thin film layer on a titanium alloy substrate material via a two-step process. As the first step, Ag-doped titanium thin film coating is deposited on the substrate material via magnetron sputtering method and then the titanium on the surface is oxidized via thermal oxidation method. Finally, by means of the titanium oxide based Ag-doped thin film coating, wear resistance and corrosion resistance are improved and an antibacterial surface is enabled to be obtained.

Chinese patent document no. CN103276393, an application known in the state of the art, discloses preparing a thin film of Nitrogen-doped Titanium layer on the surface of a stainless steel substrate by double glow plasma surface alloying technology and preparing a porous nitrogen-doped TiO₂ layer on the surface by using anodic oxidation method.

Russian patent document no. RU2524654, an application in the state of the art, discloses a multicomponent bioactive nanocomposite coating with antibacterial effect. A titanium carbonitride-based material comprising additional elements which provide mechanical and tribological properties, as well as biologically active and antibacterial properties is used as the coating material. The basic elements (X) Ti, C, N and the additional elements (Y) Ag, Ca, Zr, Si, 0, P, K, Mn are used in the coating. The coating of the invention has high hardness, low modulus of elasticity, high value of elastic recovery, low coefficient of friction and low wear rate.

New Zealand patent document no. NZ630819, an application known in the state of the art, discloses a method for producing a titanium load-bearing structure. In this method, titanium particles are deposited via cold-gas dynamic spraying on to a suitably shaped support member such as aluminum.

International Patent document no WO2010091770 an application known in the state of the art, discloses a titanium oxide based heat radiating coating material. This coating comprises titanium dioxide or a reduced titanium oxide as a base material. Titanium dioxide (TiO₂) is converted to a reduced titanium oxide when heated to a high temperature in a furnace in an atmosphere of H₂ or CO₂.

Turkish patent document no. TR 2014/13478, an application known in the state of the art, (validation of European patent document no. EP1789602) discloses a method of surface oxidizing of zirconium and zirconium alloys and resulting product. A coating of blue-black or black oxidized zirconium of uniform and controlled thickness on a zirconium or zirconium alloy material is accomplished through the oxidative treatment of an amorphous zirconium or zirconium alloy substrate having an altered surface roughness. An oxidized zirconium coating of uniform and controlled thickness is especially useful on orthopedic implants of zirconium or zirconium-based alloys to provide low friction, highly wear resistant surfaces on artificial joints, such as, but not limited to, hip joints, knee joints, shoulders, elbows, and spinal implants. The oxidized zirconium layer on prostheses provides a barrier against corrosion. The invention is also useful in non-articulating implant devices such as bone plates, bone screws, etc.

Turkish patent document no. TR 2012/09392, an application in the state of the art, discloses about coating magnesium and magnesium alloys with alumina at low temperatures. The present invention relates to a method of coating magnesium and magnesium alloys with alumina at a low temperature that will not cause internal structural change; which method is developed for use in industries such as aircraft-aerospace, chemical, food, biomedical, automotive, electric-electronic, communication industry, and comprises the process steps of preparing the surfaces of magnesium and magnesium alloys which are of light metals for coating and determining and preparing the powder that will be coated, and subsequently the process steps of coating aluminum and aluminum alloys on the said magnesium and magnesium alloys via cold gas dynamic spraying technique and converting the formed coating to alumina via micro-arc oxidation process in alkali electrolyte under high voltage and current density.

### SUMMARY

The objective of the present invention is to provide a production method for a wear resistant, antibacterial and bioactive layered thick coating having low friction coefficient.

Another objective of the present invention is to provide a layered thick coating production method which enables to form titanium oxide on the outermost surface of the coating by subjecting to thermal oxidation.

Another objective of the present invention is to provide a layered thick coating production method, which enables to fill the discontinuities that might be present in the coating structure by means of the zinc contained in the coating that causes liquid phase sintering during the thermal oxidation, and which enables to form a structurally denser coating.

Another objective of the present invention is to provide a layered thick coating production method wherein the desired requirements (antibacterial property, low friction coefficient, etc.) are met in the final product by addition of various components to the powder mixture (metallic and ceramic based powders).

### BRIEF DESCRIPTION OF THE DRAWINGS

“Production method of a thick coating with layered structure” developed to fulfill the objective of the present invention is illustrated in the accompanying figures, in which;

FIG. 1. is a view of the graphic of the friction coefficient obtained from the wear test against an alumina ball of 6 mm diameter under 4 Newton load on Co—Cr—Mo alloy and the coating produced by the method of the invention.

FIG. 2. is a view of the SEM photograph of the result of bio-activity test application on the coating in a simulated body fluid.

FIG. 3. is a view of a macro scale photograph of the result of the application of disc diffusion antibacterial test on the coating by using S-aureus bacteria.

The components shown in the figures are each given reference numbers as follows:
Co—Cr—Mo_A. Co—Cr—Mo Alloy
KN. Coated sample
KY. Coating surface
CH. Hydroxyapatite precipitated in SBF
BAB. Area decontaminated from bacteria

### DETAILED DESCRIPTION OF THE EMBODIMENTS

A thick coating production method of the present invention, which enables to form a wear resistant, antibacterial and bioactive layered thick coating having low friction coefficient, comprises the steps of
increasing surface roughness of the substrate material (Co—Cr—Mo alloy) to a level of 2-5 μm for the coating (by sanding process),
preparing powder mixtures comprising 95-90% by weight of titanium powder (pure, size <44 μm) and 5-10% by weight of zinc powder (pure, size <44 μm) for the coating process,
forming coating on a substrate surface via cold gas dynamic spraying by using air of 6 bar or higher pressure,
mechanically cleaning (via SiC grinding paper) and polishing (by using diamond or alumina suspension) the coating surface,
applying thermal oxidation process on the coating surface in air atmosphere at 500-600° C. temperature for an average of 60 hours,
obtaining the wear resistant, antibacterial and bioactive layered thick coating having low friction coefficient as the final product.

Within the scope of the invention, the powder mixture comprising zinc and titanium is coated on the metallic substrate (Co—Cr—Mo alloy) surface via cold gas dynamic spraying method. Various components (metallic and/or ceramic based powders such as Ag, ZrO, ZnO) are added to the powder mixture depending on the requirements (antibacterial property, etc.) for the final product. The surface of this coating is subjected to thermal oxidation with the purpose of forming titanium oxide on the outermost surface of the coating. The zinc contained in the coating causes liquid phase sintering during thermal oxidation whereby fills in the discontinuities that might be present in the coating structure and thus enables to form a structurally denser coating.

The method of the present invention relates to producing a layered thick coating which exhibits antibacterial property, and has high wear resistance and low friction coefficient on the surfaces of metallic materials. In the said method, the powder mixture comprising zinc and titanium is coated by using cold gas dynamic spraying method (2^{nd} process) over a metallic substrate whose surface is roughened (1^{st} process), and then this coating is subjected to thermal oxidation (3^{rd} process) for forming titanium oxide on the outermost surface.

Thanks to the fact that the metallic powders, which are sprayed during the cold gas dynamic spraying applied after the process of surface roughening, do not rise to relatively high temperatures, composition of the coating formed on the surface of the metallic substrate materials is not different from the powder composition. During the cold gas dynamic spraying process, the fact that the temperature of the sprayed metallic powders does not exceed 150-200° C. enables the structure of the sprayed powders to be the same as the coating structure that is formed. A notable oxidation is not observed on the powders during spraying. In this method, the coating properties obtained can be changed in a wide range by means of the metallic and/or ceramic based powders that will be added to the sprayed powder mixture at different ratios. For example; in cases where wear is critical, ceramic powders (e.g. (ZrO₂, ZnO); and in cases where antibacterial property is critical, antibacterial metallic powders (e.g. Zn, Cu, Ag) can be added to titanium powders. The titanium based coating produced by cold gas dynamic spraying is subjected to thermal oxidation in atmospheric condition at 500-600° C. Thickness of the titanium oxide layer formed on the outermost surface of the coating increases depending on the period of thermal oxidation, and this thickness reaches 3 μm in 60 hours at 600° C. The zinc contained in the coating during thermal oxidation causes liquid phase sintering whereby fills in the discontinuities that might be present in the coating structure and thus forms a structurally denser coating. As a result of these processes, hardness of the coating increases, its wear resistance is improved and its friction coefficient decreases. In addition to these, the coating exhibits improved bioactivity and antibacterial property.

In the method of the present invention, the powder sprayed on the substrate material whose surface is roughened contains 5-10% by weight of zinc in order to provide a low friction coefficient to the coating. As a result of the cold gas dynamic spraying process, a titanium and zinc containing metallic coating having a thickness up to 200 μm can be formed on the substrate material. When aluminum, silver, ceramics, etc. are added in powder form to the sprayed mixture, the properties of the coating can be changed in a wide range. In the method of the present invention, while the material to be coated contains a mixture of different powders, the coating that is obtained stands out with its bioactivity as well as its antibacterial property and the low friction coefficient it exhibits during the wear test. Presence of a high ratio of titanium in this coating (preferably 90-95% by weight) is associated with the high affinity of titanium to oxygen. By means of the thermal oxidation process (in atmospheric conditions for 60 hours at 500-600° C.), which is the 3^{rd} process of the invention, a titanium oxide layer with a thickness of 2-3 μm is formed on the outermost surface. As a result of this process, the coating is converted into a layered structure and acquires the feature of exhibiting high hardness and wear resistance as well as low friction coefficient.

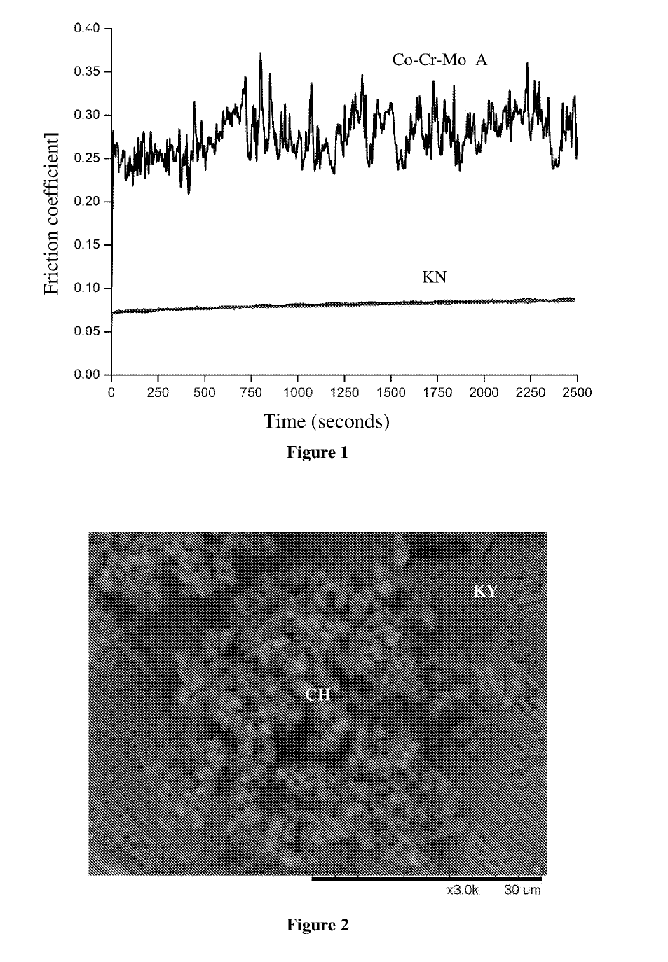

The coating formed in the scope of the invention is suitable for the engineering applications (automotive, aircraft, etc.) wherein friction and wear are active. Under dry ambient conditions where no lubrication is carried out, friction coefficient of this coating under 4N load is <0.1. Due to this feature thereof, the layered coating of the present invention has the potential of limiting use of the lubricant, which is used for reducing friction and wear in engineering applications, and which has negative impacts on the environment. The coating applied on the Co—Cr—Mo alloy was subjected to wear test by a reciprocating wear test device against an alumina ball with 6 mm diameter under a 4 Newton load under dry sliding conditions (normal atmospheric conditions) and the graphic of the obtained friction coefficient is shown in FIG. 1. The wear tests conducted in a dry sliding condition that the coating of the present invention provides important advantages in protecting the substrate material by increasing the wear resistance and decreasing the friction coefficient in engineering applications where wear and friction are important.

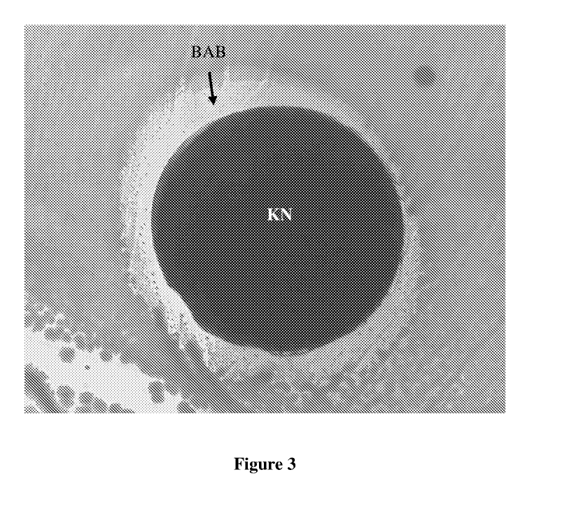

The fact that titanium oxide is bioactive enables the coating of the present invention to be used in biomedical sector (For example: for orthopedic implants requiring biocompatibility together with high wear resistance). The zinc added to the coating has the advantage of providing antibacterial property to the coating as well as low friction coefficient. Therefore, the layered coating of the present invention can also find use in sectors where antibacterial surfaces are sought. Taking into consideration the positive effects of zinc on the biological activity in the human body, the fact that the coating contains zinc makes the layered coating of the invention even more attractive for the medical sector. In this context, bioactivity test was applied in simulated body fluid and disc diffusion antibacterial activity test was applied by using S-aureus bacteria to the coating, and the results are shown in FIGS. 2 and 3, respectively. The results of the wear, bioactivity and antibacterial activity tests disclose that the layered coating of the present invention contributes to improvement of the performance and properties of the implants.

The facts that the coating of the invention does not harm the mechanical properties of the metallic materials and improves bioactivity and antibacterial properties and decreases friction coefficient while increasing wear resistance show that the method of the present invention can constitute an alternative to the state of the art applications. Components whose surfaces are coated by the present method have structures and properties suitable for being used in various engineering applications in sectors such as automotive, aircraft, chemical, biomedical, etc.

What is claimed is:

1. A method of production of a thick coating with layered structure, which enables to form a wear resistant, antibacterial and bioactive layered thick coating having low friction coefficient, the method comprising:
increasing surface roughness of a substrate material to a level of 2-5 μm for the thick coating b a sanding process, wherein the substrate material is Co—Cr—Mo alloy;
preparing a powder composition containing 90%-95% of pure titanium having a particle size of (<44 μm) and 5%-10% of pure zinc having a particle size of (<44 μm) for a coating process, forming coating on the substrate surface via cold gas dynamic spraying technique;
adding at least one ceramic powder selected from the group consisting of ZrO₂, ZnO, and Al₂O₃ into the powder composition in order to increase the wear resistance in a final product;
adding at least one antibacterial metallic powder selected from the group consisting of Zn, Cu, and Ag into the powder composition in order to increase the antibacterial property in the final product;
mechanically cleaning a coating surface via SiC grinding paper, and, polishing the coating surface by using a diamond or alumina suspension;
applying thermal oxidation process on the coating surface in air atmosphere at 500-600° C. temperature for an average of 60 hours by means of the thermal oxidation, producing a titanium oxide layer with a thickness of 2-3 μm formed on an outermost surface;
obtaining the wear resistant, antibacterial and bioactive layered thick coating having a thickness up to 200 μm as the final product.

2. (canceled)

3. The method of claim 1, wherein, a temperature of metallic powders during a spraying process is kept at 150-200° C. in order to ensure that a structure of the sprayed metallic powders is the same as a structure of coating during a cold gas dynamic spraying process.

4. (canceled)

5. The method of claim 1, wherein, the thick coating is formed on the substrate surface via cold gas dynamic spraying by using air of 6 bars or higher pressure via a cold gas dynamic spraying technique.

6. The method of claim 1, wherein, a titanium and zinc containing metallic coating having a thickness of 100-200 μm is produced via a cold gas dynamic spraying process.

7.-9. (canceled)
